(19) United States
(12) Patent Application Publication
(10) Pub. No.: US 2014/0244287 A1
(43) Pub. Date: Aug. 28, 2014

(54) FRONT END REVENUE CYCLE MANAGEMENT MULTI-INTERFACE SOFTWARE AND METHOD

(71) Applicant: Sandip Mukherjee, Forest Hills, NY (US)

(72) Inventor: Sandip Mukherjee, Forest Hills, NY (US)

(21) Appl. No.: 14/189,713

(22) Filed: Feb. 25, 2014

Related U.S. Application Data
(60) Provisional application No. 61/769,597, filed on Feb. 26, 2013.

(51) Int. Cl. G06F 19/00

(52) U.S. Cl. CPC G06F 19/328
USPC 705/2

(57) ABSTRACT

A system for informing a healthcare provider a patient's insurance claim information prior to the patient receiving health services. The system may include the patient entering in pertinent information regarding an insurance claim into a portable computer. The pertinent information is sent to a secure server. The secure server sends the information to an eligibility vendor which either confirms or denies a match of patient information. The match information may be provided to the healthcare provider to determine whether it is proper for the healthcare provider to provide services to the patient.

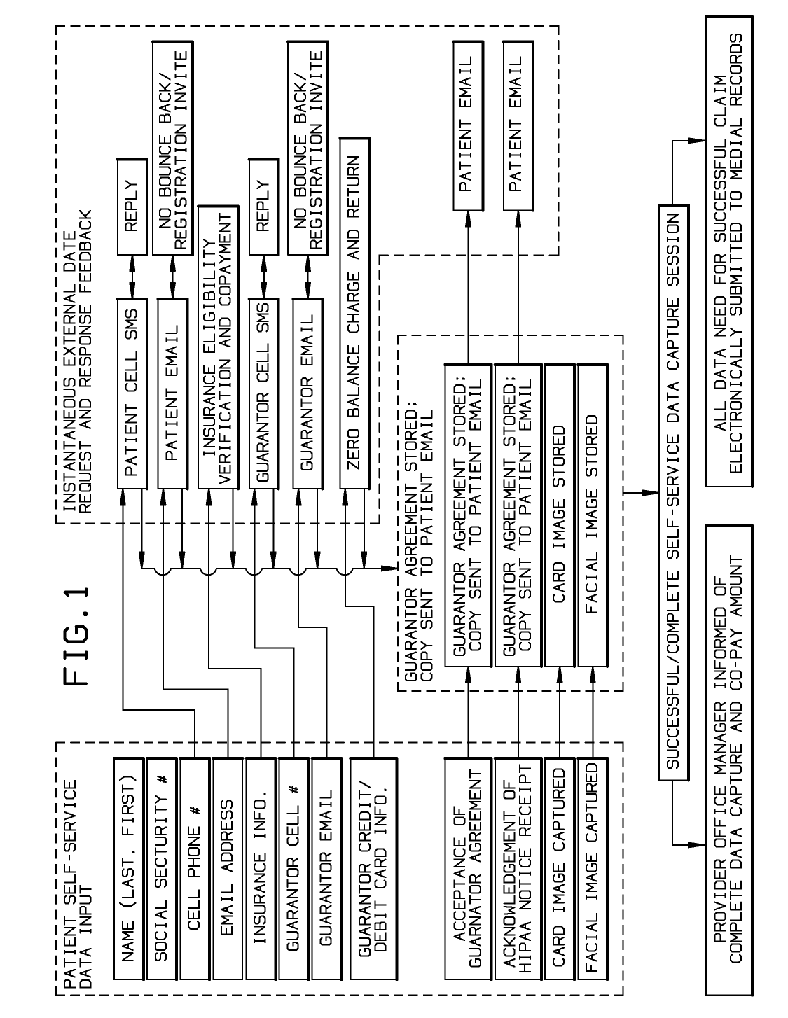

### CROSS-REFERENCE TO RELATED APPLICATION

This application claims the benefit of priority of U.S. provisional application No. 61/769,597, filed Feb. 26, 2013, the contents of which are herein incorporated by reference.

### BACKGROUND OF THE INVENTION

The present invention relates to a front-end revenue cycle management multi-interface software and method.

Loss of health care revenue due to errant patient information in-take prior to a health care service continues to be a major problem within the healthcare sector. There is currently no software platform available, during patient registration, which creates a patient self-service terminal, from readily available electronics in the consumer market place, capable of collecting all pertinent information needed to ensure a health care provider has a perfected claim for presentation to a health insurance company. The traditional health care setting depends on at least three to four staffers, including billing company personnel. Currently, there is no software platform available which offers this comprehensive capability before the patient is ever seen by a healthcare provider.

As can be seen, there is a need for solutions to these and other problems.

### SUMMARY OF THE INVENTION

In one aspect of the present invention, a method for verifying patient information prior to a healthcare service comprises: prompting a patient to enter information onto a secure server, wherein the information comprises pertinent information regarding an insurance claim; sending the entered information from the secure server to an eligibility vendor amongst others; comparing information about the patient that is stored by the eligibility vendor with the entered information; and sending information through the software platform, and its associated secure server, to a healthcare provider regarding the compared stored information and the entered information.

In another aspect of the present invention, a system for verifying patient information prior to a healthcare service, comprises: a computer having a user interface; and a program product comprising machine-readable program code for causing, when executed, the computer to perform the following process steps: prompting a patient to enter information through the software platform onto a secure server, wherein the information comprises pertinent information regarding an insurance claim; sending the entered information from the secure server to an eligibility vendor; comparing information about the patient that is stored by the eligibility vendor with the entered information; and sending information to a healthcare provider regarding the compared stored information and the entered information.

These and other features, aspects and advantages of the present invention will become better understood with reference to the following drawings, description and claims.

### BRIEF DESCRIPTION OF THE DRAWINGS

The FIGURE is a schematic view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for informing healthcare providers a patient's insurance claim information prior to the patient receiving health services. The system may include the patient entering in pertinent information regarding an insurance claim into a portable computer. The pertinent information is sent to a secure server. The secure server sends the information to an eligibility vendor, amongst others, which either confirms or denies a match of patient information. The match information shall be provided to the healthcare provider to determine whether it is proper for the healthcare provider to provide services to the patient.

The present invention is software using current available computing devices as patient self-service terminals to collect pertinent patient information needed to ensure that a health care provider has a perfected claim for presentation to a health insurance company. The definition of pertinent data can be modified as the needs of the healthcare industry change. The information may include, but is not limited to, the patient's name, address, cell phone number, email, guarantor contact information and insurance information. A successful patient self-service session utilized with a terminal of the present invention may capture the pertinent data for claims submission, real time verification of insurance and/or guarantor information, delivery of required legal documentation/disclosures as well as a prompt to healthcare clerical staff indicating whether a copayment is required. Due to the present invention, an incomplete capture of the pertinent data would alert the healthcare provider and could prevent the expenditure of healthcare resources that may not be reimbursable.

The present invention allows for a provider to collect pertinent information for a downstream medical billing company at the beginning of the healthcare revenue cycle process. Additionally, this software can streamline the staff needed for patient registration and intake which is beneficial in the current low-margin healthcare reimbursement models that exist today. Additionally, the present invention can directly interface with the health care providers' billing company to provide seamless transfer of patient demographic, insurance and guarantor information. Additionally, the software may be able to deliver an electronic Health Insurance Portability and Accountability Act (HIPAA) notice and acknowledgment screen to the patient as well as a guarantor agreement with associated acknowledgement screen. In certain embodiments, during follow up visits, the patient may log in at the waiting room of the health care provider and learn whether a copayment is needed as well as inform an office manager that there is a patient responsibility payment. In certain embodiments, the software may be available in several languages.

Referring to the FIGURE, the present invention may include software that is loaded on a computing device. The computing device may include a smart device, such as a smart phone, tablet, or other mobile processor. The patient may be prompted to enter data that is pertinent to an insurance claim when presented to an insurance company. The pertinent data may include, but is not limited to, the patients name, social security number, phone number, email address, and insurance information. A guarantor's information may also be provided. For example, the guarantor's phone number, email, credit or debit card information, acceptance of guarantor agreement, acknowledgment of HIPAA notice receipt, insurance card image, and facial image may be submitted.

In certain embodiments, the patient may enter credit/debit card information when prompted by the software. The information is then sent, but not stored, on the secure server to a credit card processing vendor which stores the information and submits a zero balance charge. Upon the credit card processing vendor receiving a response that the zero balance charge was processed—the vendor may return a message to the software associated secure server indicating a successful transaction. The software may then indicate to the physician's office that accurate credit/debit card information is available for payment of patient responsibility amounts owed.

Once the pertinent information has been gathered, the information may be sent to a HIPAA secure server, and encrypted. The secure server may store the information in a database for future use. The secure server may also send the information to eligibility vendors. The eligibility vendors may provide data for comparison with patient entered pertinent information which the software platform shall identify as a match or not a match. The results of the match of the entered pertinent information and the information provided by the eligibility vendors are sent directly to the secure server which in turn sends the information to the computer at the physician's office.

Further, the software platform may forward the healthcare provider's billing company the patient's pertinent information. Alternatively, if the entered pertinent patient information does not match the stored information of the eligibility vendor, the physician's office may be informed of such an outcome and be provided the option not to provide services to the patient. The patient may be asked to correct entered information, or alternatively to pay for the services that will be provided by the physician's office.

The nature of the responses collected by the software will allow the physician's office to either stop a healthcare service from occurring or continue with the visit and ensure all pertinent patient information is collected. If there is incomplete information, the physician's office may stop a healthcare visit or use discretion in gathering the appropriate information for downstream reimbursement for the health care service. The physician's office may also be instructed to collect any patient responsibility payments if needed. This entire process may be easy and instantaneous using interfaces created by the software on the physician's office computer and the computing device used by the patient.

A method of using the present invention may include the following. Upon selection of the patient's preferred language, a series of questions may be presented to the patient in order to collect all pertinent information for submission of a health care claim on the front end of the revenue cycle management process. The patient's cell phone and email may receive an automated registration text/email that will be monitored for bounce back, guarantor information and guarantor agreement acceptance, HIPAA notice as well as confirmation of understanding of provider's HIPAA policy. Upon collection of insurance and/or guarantor data a real time verification of insurance and/or guarantor information may occur through HIPAA secure electronic pathways. The guarantor agreement and HIPAA policy affirmation are stored for subsequent retrieval.

Successful collection of all required data may result in a prompt to the physician's office to request any required patient responsibility payment and also ensure that the health care entity has all possible information needed for a medical billing company to proceed with claims submission to an insurance company or medical guarantor. The conclusion of the intake process powered by the software may result in electronic transmission of claim pertinent data to the medical billing company.

A health care provider entity, whether a small office or a hospital, may easily capture patient demographic/insurance/guarantor information, which is critical to payment of a claim when submitted to an insurance carrier. The absence of such information can result in delayed claims processing or possibly denial. Implementation of the present invention may include the user of two computing devices and a secure internet connection. The benefits include higher medical collections as well less need for large numbers of clerical staff.

In alternative embodiments, potential uses of the present invention may include industries where high dollar items are sold or leased and need a quick collection of personal/banking/credit information and possible electronic verification so as to pre-screen or qualify purchasers. Examples might be auctions, casinos, car dealerships and real property sales/leases to name a few.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A method for verifying patient information prior to a healthcare service comprising:
prompting a patient to enter information onto a secure server, wherein the information comprises pertinent information regarding an insurance claim;
sending the entered information from the secure server to an eligibility vendor;
comparing information about the patient that is provided by the eligibility vendor with the entered information; and
sending the compared information to a healthcare provider.

2. The method of claim 1, further comprising the step of producing an electronic version of a Health Insurance Portability and Accountability Act notice to the patient.

3. The method of claim 1, wherein the entered information comprises the patient's name, address, cell phone number, email, guarantor contact information of a guarantor, and insurance information.

4. The method of claim 3, further comprising the step of sending an executed guarantor agreement to the patient.

5. The method of claim 4, wherein the entered information further comprises a credit or debit card information.

6. The method of claim 5, further comprising the step of sending the credit or debit card information to the credit card processing vendor, wherein the credit card processing vendor verifies the validity of the credit or debit card information.

7. The method of claim 1, further comprising the step of entering an image of the patient and the patient's insurance card.

8. The method of claim 1, further comprising the step of sending a verified match of the vendor provided information and the entered information to the healthcare provider and a billing company.

9. The method of claim 1, further comprising the step of sending an indication of a mismatch of the vendor provided information and the entered information to the healthcare provider and the patient.

10. The method of claim 9, further comprising the step of prompting the patient to correct the entered information.

11. The method of claim 1, wherein the information sent to the secure server is encrypted.

12. The method of claim 1, wherein the patient enters the information on a portable computer.

13. The method of claim 12, wherein the portable computer is at least one of a tablet and a smart phone.

14. The method of claim 12, wherein the information is entered in the healthcare provider's office.

15. A system for verifying patient information prior to a healthcare service, comprising:
a computer having a user interface; and
a program product comprising machine-readable program code for causing, when executed, the computer to perform the following process steps:
prompting a patient to enter information onto a secure server, wherein the information comprises pertinent information regarding an insurance claim;
sending the entered information from the secure server to an eligibility vendor;
comparing information about the patient that is provided by the eligibility vendor with the entered information; and
sending the compared information to a healthcare provider.

16. The system of claim 15, wherein the entered information comprises the patient's name, address, cell phone number, email, guarantor contact information, and insurance information.

17. The system of claim 15 further comprising the step of entering an image of the patient and the patient's insurance card.

18. The system of claim 15, further comprising the step of sending verified a match of the vendor provided information and the entered information to the healthcare provider and a billing company.

19. The system of claim 15, further comprising the step of sending an indication of a mismatch of the vendor provided information and the entered information to the healthcare provider and the patient.

20. The method of claim 19, further comprising the step of prompting the patient to correct the entered information.

21. The method of claim 15, wherein the information sent to the secure server is encrypted.

22. The method of claim 15, wherein the patient enters the information on a portable computer.
